(19) United States
(12) Patent Application Publication
(10) Pub. No.: US 2002/0162426 A1
(43) Pub. Date: Nov. 7, 2002

(54) Extension structure for tool

(76) Inventor: Tian-Ming Lee, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/026,787

(22) Filed: Dec. 27, 2001

(30) Foreign Application Priority Data
May 2, 2001 (TW) 090207229

(51) Int. Cl. B25B 23/16

(52) U.S. Cl. 81/177.85

(57) ABSTRACT

A extension structure for a tool includes a joint body, a drive rod, and a rotation control member. The rotation control member may be rotated to change the position of the drive rod, so that a locking ball may protrude the joint body to lock a workpiece, and may retract into the joint body to detach the workpiece.

### BACKGROUND OF THE INVENTION

1. Field of the Invention

The present invention relates to an extension structure for a tool such as a wrench or the like, and more particularly to an extension structure which may be assembled easily and quickly, and may have a rigid construction without detachment.

2. Description of the Related Art

The closest prior art of which the applicant is aware is disclosed in the Taiwanese Patent Publication No. 88221334, entitled by “Joint Body of Wrench Extension”, which disclosed a wrench extension including a joint body, a push ring, and relative push and locking mechanisms. However, the structure of the wrench extension is complicated, and cannot be assembled easily, thereby causing inconvenience in assembly, and thereby increasing cost of fabrication.

### SUMMARY OF THE INVENTION

The present invention has arisen to mitigate and/or obviate the disadvantage of the conventional wrench extension.

The primary objective of the present invention is to provide an extension structure which may be assembled easily and quickly, and may have a rigid construction without detachment.

In accordance with the present invention, there is provided an extension structure for a tool, comprising:

an elongated cylindrical joint body having a first end formed with a rectangular locking end, and a second end formed with a mounting portion, the locking end formed with a ball receiving hole for receiving a locking ball, the joint body having a center formed with an elongated central hole, a drive rod slidably mounted in the central hole, the drive rod having a first end formed with an arcuate push recess for receiving the locking ball;

wherein, the central hole has a distal end formed with a closed wall, a push spring is mounted in the central hole, and is biased between the closed wall of the central hole and a second end of the drive rod, the joint body is formed with a shaft hole that is communicated with the central hole and is directed toward a direction vertical to that of the central hole, the second end of the drive rod is formed with a passage slot that is directed toward a direction vertical to that of the central hole, a rotation control member is rotatably mounted on the joint body, and has a top formed with a knob protruding outward from the joint body and a bottom formed with a drive section secured in the passage slot, and the drive section of the rotation control member has a bottom formed with a circular enlarged head which is passed through the shaft hole and the passage slot, and rested on a bottom wall of the passage slot.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an extension structure for a tool in accordance with a first embodiment of the present invention;

FIG. 2 is a partially cut-away top plan cross-sectional assembly view of the extension structure for a tool as shown in FIG. 1;

FIG. 3 is a front plan cross-sectional assembly view of the extension structure for a tool as shown in FIG. 1;

FIG. 4 is a schematic operational view of the extension structure for a tool as shown in FIG. 2;

FIG. 5 is a schematic operational view of the extension structure for a tool as shown in FIG. 3;

FIG. 6 is an exploded perspective view of an extension structure for a tool in accordance with a second embodiment of the present invention;

FIG. 7 is a front plan cross-sectional assembly view of the extension structure for a tool as shown in FIG. 6;

FIG. 8 is a schematic operational view of the extension structure for a tool as shown in FIG. 7;

FIG. 9 is an exploded perspective view of an extension structure for a tool in accordance with a third embodiment of the present invention;

FIG. 10 is a perspective view of an extension structure for a tool in accordance with a fourth embodiment of the present invention;

FIG. 11 is a front plan cross-sectional assembly view of an extension structure for a tool in accordance with a fifth embodiment of the present invention; and

FIG. 12 is a front plan cross-sectional assembly view of an extension structure for a tool in accordance with a sixth embodiment of the present invention.

### DETAILED DESCRIPTION OF THE INVENTION

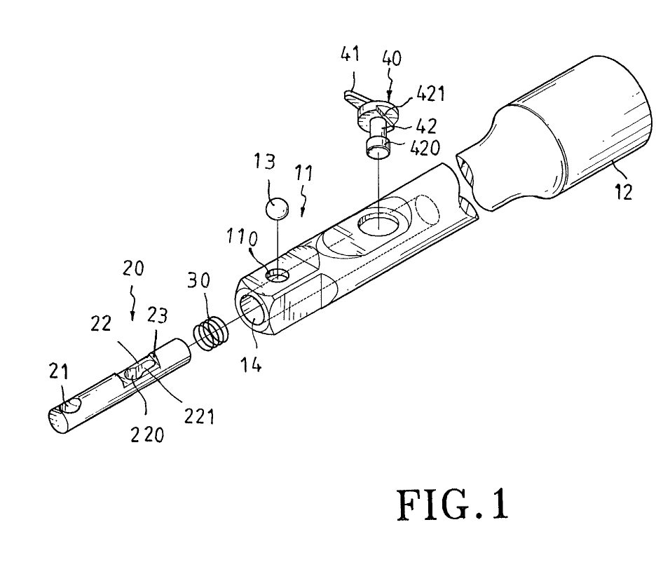

Referring to the drawings and initially to FIG. 1, an extension structure for a tool such as a wrench or the like in accordance with a first embodiment of the present invention comprises an elongated cylindrical joint body 10 having a first end formed with a rectangular locking end 11, and a second end formed with a mounting portion 12. The locking end 11 is formed with a ball receiving hole 110 for receiving a locking ball 13. The joint body 10 has a center formed with an elongated central hole 14, and a drive rod 20 is slidably mounted in the central hole 14. The drive rod 20 has a first end formed with an arcuate push recess 21 for receiving the locking ball 13.

The central hole 14 has a distal end formed with a closed wall. A push spring 30 is mounted in the central hole 14, and is biased between the closed wall of the central hole 14 and a second end of the drive rod 20. The joint body 10 is formed with a shaft hole 15 that is communicated with the central hole 14, and is directed toward a direction vertical to that of the central hole 14. The shaft hole 15 of the joint body 10 has a top formed with an opening having a large diameter, and a bottom formed with a closed wall. The second end of the drive rod 20 is formed with a passage slot 22 that is directed toward a direction vertical to that of the central hole 14.

A disk-shaped rotation control member 40 is rotatably mounted on the joint body 10, and has a top formed with an l-shaped knob 41 protruding outward from the joint body 10, and a bottom formed with a drive section 42 and an oblique guide face 421. The drive section 42 of the rotation control member 40 has a bottom formed with a circular enlarged head 420 which is passed through the shaft hole 15 and the passage slot 22.

The passage slot 22 of the drive rod 20 has the shape of a keyhole, and has a first end formed with a passage portion 22, and a second formed with a positioning portion 221 having a diameter smaller than that of the passage portion 220. The enlarged head 420 of the rotation control member 40 is initially passed through the shaft hole 15 of the joint body 10 and through the passage portion 220 of the passage slot 22, and the drive section 42 of the rotation control member 40 is then inserted into the positioning portion 221 of the passage slot 22. At this time, the enlarged head 420 of the rotation control member 40 is rested and locked on a bottom wall of the positioning portion 221 of the passage slot 22, so that the rotation control member 40 and the drive rod 20 may be combined integrally and cannot be separated from each other. Thus, the drive section 42 of the rotation control member 40 may slide in the positioning portion 221 of the passage slot 22 without detachment.

The passage slot 22 has a distal end formed with an oblique guide edge 23 engaging the guide face 421 of the rotation control member 40, so that the movement of the drive rod 20 may be controlled by rotating the rotation control member 40 to change the relative position of the guide edge 23 and the guide face 421.

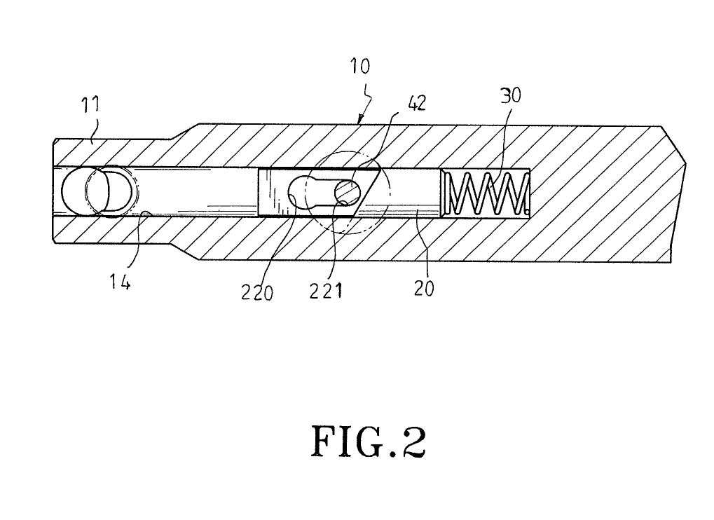

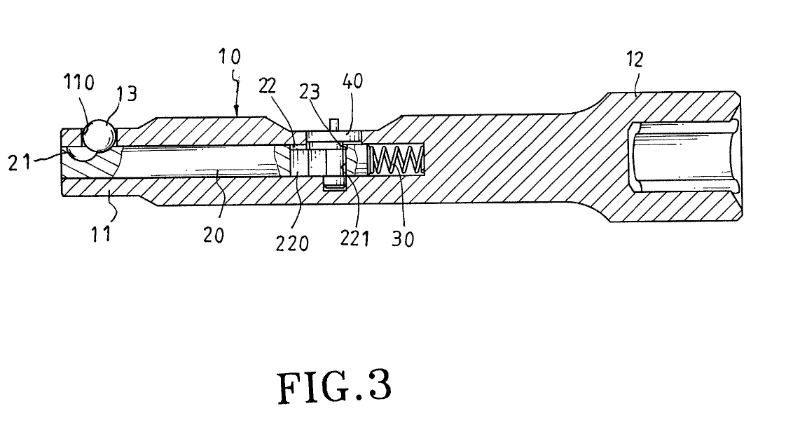

In operation, the guide edge 23 is initially rested on the guide face 421, and the drive rod 20 is pushed by the push spring 30 to move outward relative to the joint body 10, so that the locking ball 13 is pushed by the push recess 21 of the drive rod 20 to protrude outward from the ball receiving hole 110 of the joint body 10 as shown in FIG. 3. At this time, the drive section 42 of the rotation control member 40 is secured in the positioning portion 221 of the passage slot 22 as shown in FIG. 2.

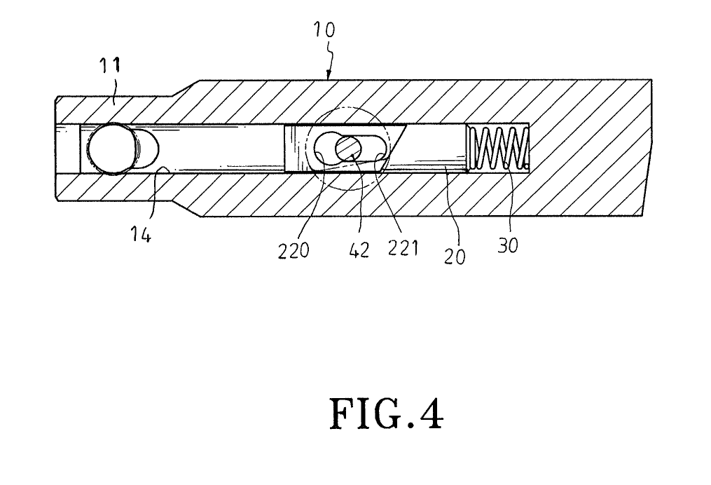

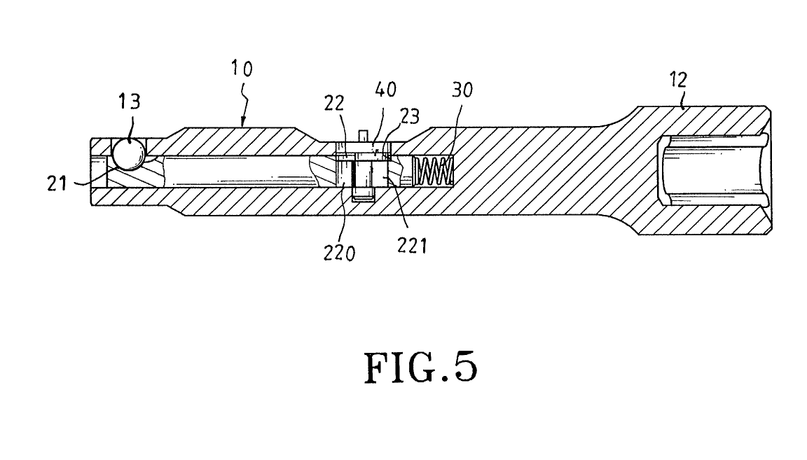

Then, the rotation control member 40 may be rotated by the knob 41 to separate the guide edge 23 from the guide face 421. At the same time, the guide edge 23 is pressed by the outer periphery of the guide face 421, whereby the drive rod 20 is moved toward the push spring 30 in the central hole 14 of the joint body 10, to compress the push spring 30, so that the locking ball 13 is received in the push recess 21 of the drive rod 20 to retract inward from the ball receiving hole 110 of the joint body 10 as shown in FIG. 5. At this time, the drive section 42 of the rotation control member 40 slides in the positioning portion 221 of the passage slot 22 as shown in FIG. 4.

In assembly, the drive rod 20 may be pressed into the central hole 14 of the joint body 10 to compress the push spring 30 until the passage hole 22 aligns with the shaft hole 15. Then, the enlarged head 420 of the rotation control member 40 is passed through the shaft hole 15 of the joint body 10 and through the passage portion 220 of the passage slot 22. Then, the drive section 42 of the rotation control member 40 is inserted into and secured in the positioning portion 221 of the passage slot 22 by pressing of the push spring 30. At this time, the enlarged head 420 of the rotation control member 40 is rested and locked on the bottom wall of the positioning portion 221 of the passage slot 22, so that the rotation control member 40 and the drive rod 20 may be combined integrally and cannot be separated from each other.

Accordingly, the extension structure for a tool such in accordance with the present invention may be assembled easily and quickly, and may have a rigid construction without detachment.

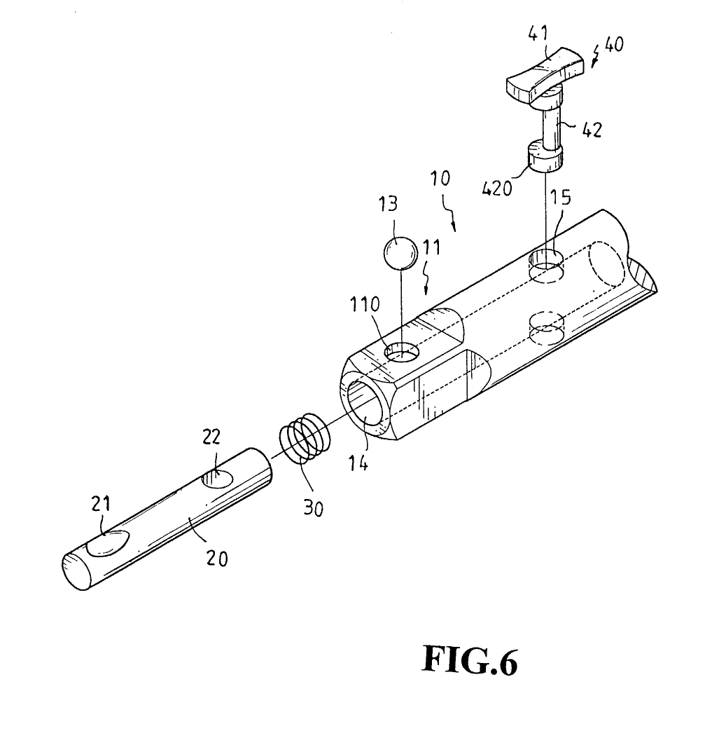

Referring to FIGS. 6-8, an extension structure for a tool such as a wrench or the like in accordance with a second embodiment of the present invention comprises an elongated cylindrical joint body 10 having a first end formed with a rectangular locking end 11. The locking end 11 is formed with a ball receiving hole 110 for receiving a locking ball 13. The joint body 10 has a center formed with an elongated central hole 14, and a drive rod 20 is slidably mounted in the central hole 14. The drive rod 20 has a first end formed with an arcuate push recess 21 for receiving the locking ball 13.

The central hole 14 has a distal end formed with a closed wall. A push spring 30 is mounted in the central hole 14, and is biased between the closed wall of the central hole 14 and a second end of the drive rod 20. The joint body 10 is formed with a shaft hole 15 that is communicated with the central hole 14, and is directed toward a direction vertical to that of the central hole 14. The second end of the drive rod 20 is formed with a passage slot 22 that is directed toward a direction vertical to that of the central hole 14.

A rotation control member 40 is rotatably mounted on the joint body 10, and has a top formed with an l-shaped knob 41 protruding outward from the joint body 10, and a bottom formed with a drive section 42. The drive section 42 of the rotation control member 40 has a bottom formed with a circular enlarged head 420 which is passed through the shaft hole 15 and the passage slot 22. The drive section 42 of the rotation control member 40 is eccentrically located on the circular enlarged head 420 of the rotation control member 40.

The enlarged head 420 of the rotation control member 40 is initially passed through the shaft hole 15 of the joint body 10 and through the passage slot 22, and the drive section 42 of the rotation control member 40 is then inserted into the passage slot 22. At this time, the second end of the drive rod 20 is pushed by the push spring 30, so that the enlarged head 420 of the rotation control member 40 is rested and locked on a bottom wall of the passage slot 22, and the rotation control member 40 and the drive rod 20 may be combined integrally and cannot be separated from each other. Thus, the drive section 42 of the rotation control member 40 may slide in the passage slot 22 without detachment.

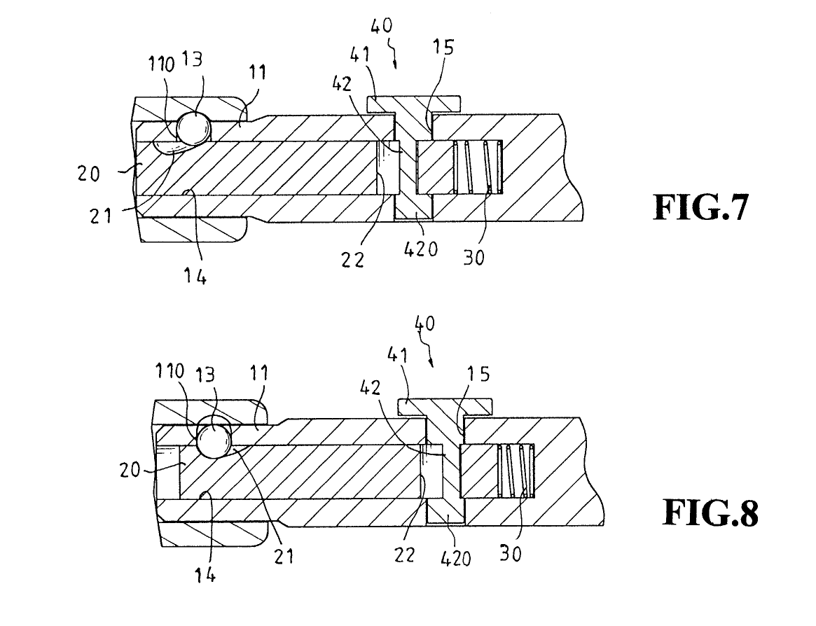

In operation, the drive rod 20 is pushed by the push spring 30 to move outward relative to the joint body 10, so that the locking ball 13 is pushed by the push recess 21 of the drive rod 20 to protrude outward from the ball receiving hole 110 of the joint body 10 as shown in FIG. 7.

Then, the rotation control member 40 may be rotated by the knob 41, so that the drive section 42 of the rotation control member 40 may be eccentrically rotated on the circular enlarged head 420 of the rotation control member 40 from the position as shown in FIG. 7 to the position as shown in FIG. 8, whereby the drive rod 20 is moved toward the push spring 30 in the central hole 14 of the joint body 10, to compress the push spring 30, so that the locking ball 13 is received in the push recess 21 of the drive rod 20 to retract inward from the ball receiving hole 110 of the joint body 10 as shown in FIG. 8.

In assembly, the drive rod 20 may be pressed into the central hole 14 of the joint body 10 to compress the push spring 30 until the passage hole 22 aligns with the shaft hole 15. Then, the enlarged head 420 of the rotation control member 40 is passed through the shaft hole 15 of the joint body 10 and through the passage slot 22. Then, the drive section 42 of the rotation control member 40 is inserted into and secured in the passage slot 22 by pressing of the push spring 30. At this time, the enlarged head 420 of the rotation control member 40 is rested and locked on the bottom wall of the passage slot 22, so that the rotation control member 40 and the drive rod 20 may be combined integrally and cannot be separated from each other.

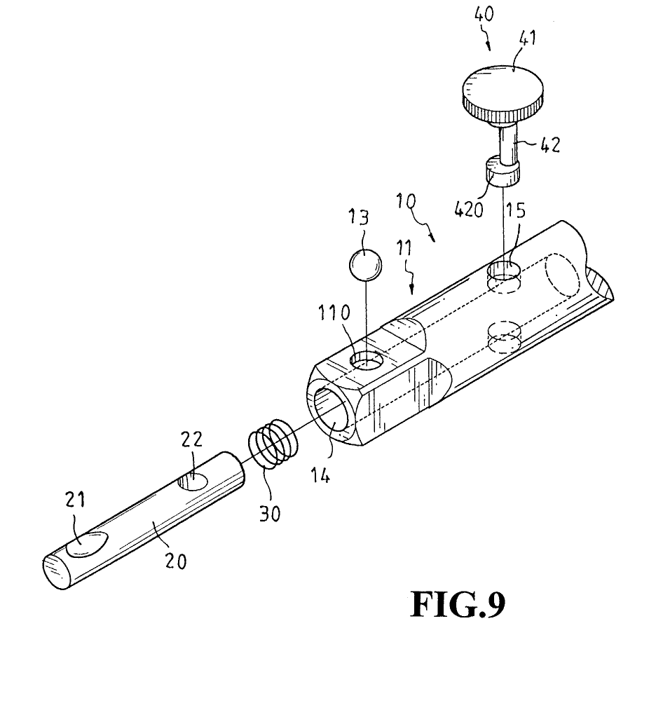

Referring to FIG. 9, an extension structure for a tool such as a wrench or the like in accordance with a third embodiment of the present invention is shown, wherein the rotation control member 40 is formed with a disk-shaped knob 41 protruding outward from the joint body 10.

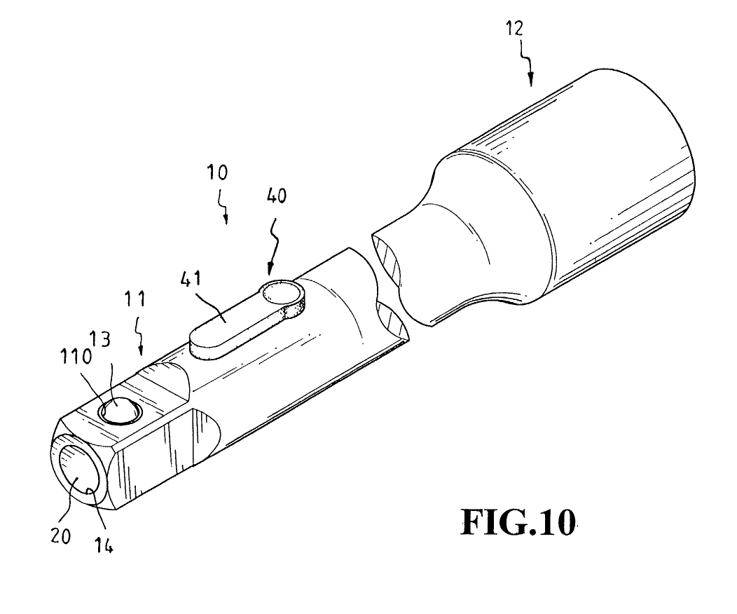

Referring to FIG. 10, an extension structure for a tool such as a wrench or the like in accordance with a fourth embodiment of the present invention is shown, wherein the rotation control member 40 is formed with an elongated knob 41 protruding outward from the joint body 10.

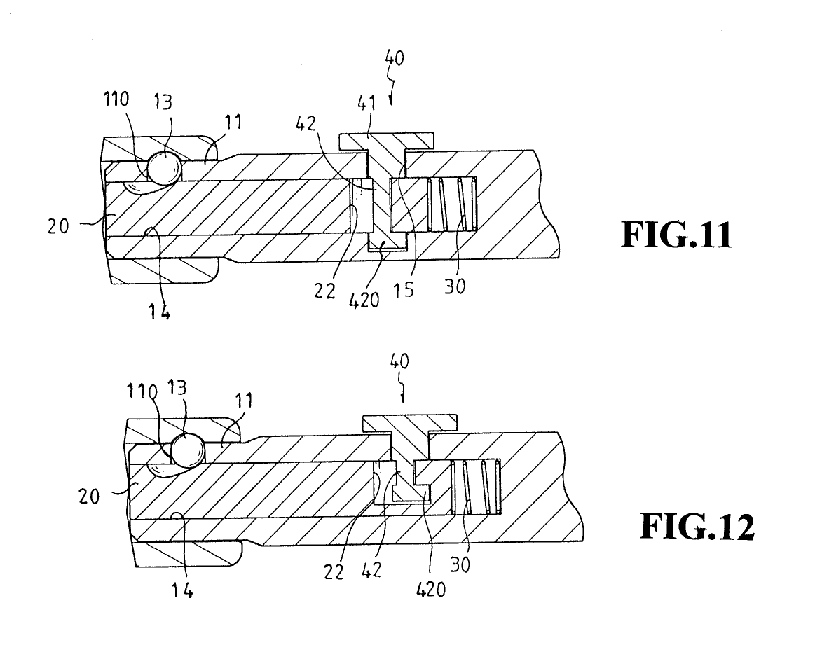

Referring to FIG. 11, an extension structure for a tool such as a wrench or the like in accordance with a fifth embodiment of the present invention is shown, wherein the shaft hole 15 is not extended through the joint body 10.

Referring to FIG. 12, an extension structure for a tool such as a wrench or the like in accordance with a sixth embodiment of the present invention is shown, wherein the passage slot 22 is not extended through the drive rod 20.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An extension structure for a tool, comprising:
an elongated cylindrical joint body having a first end formed with a rectangular locking end, and a second end formed with a mounting portion, the locking end formed with a ball receiving hole for receiving a locking ball, the joint body having a center formed with an elongated central hole, a drive rod slidably mounted in the central hole, the drive rod having a first end formed with an arcuate push recess for receiving the locking ball;
wherein, the central hole has a distal end formed with a closed wall, a push spring is mounted in the central hole, and is biased between the closed wall of the central hole and a second end of the drive rod, the joint body is formed with a shaft hole that is communicated with the central hole and is directed toward a direction vertical to that of the central hole, the second end of the drive rod is formed with a passage slot that is directed toward a direction vertical to that of the central hole, a rotation control member is rotatably mounted on the joint body, and has a top formed with a knob protruding outward from the joint body and a bottom formed with a drive section secured in the passage slot, and the drive section of the rotation control member has a bottom formed with a circular enlarged head which is passed through the shaft hole and the passage slot, and rested on a bottom wall of the passage slot.

2. The extension structure for a tool in accordance with claim 1, wherein the shaft hole of the joint body has a top formed with an opening and a bottom formed with a closed wall, the passage slot of the drive rod has a shape of a keyhole, and has a first end formed with a passage portion, and a second formed with a positioning portion having a diameter smaller than that of the passage portion, the enlarged head of the rotation control member is passed through the shaft hole of the joint body and through the passage portion of the passage slot, the drive section of the rotation control member is inserted into and secured in the positioning portion of the passage slot, and the enlarged head of the rotation control member is rested and locked on a bottom wall of the positioning portion of the passage slot, so that the rotation control member and the drive rod are combined integrally and cannot be separated from each other.

3. The extension structure for a tool in accordance with claim 1, wherein the bottom of the rotation control member is formed with an oblique guide face, and the passage slot has a distal end formed with an oblique guide edge engaging the guide face of the rotation control member so that movement of the drive rod may be controlled by rotating the rotation control member to change a relative position of the guide edge and the guide face.

4. The extension structure for a tool in accordance with claim 1, wherein the knob of the rotation control member is l-shaped.

5. The extension structure for a tool in accordance with claim 1, wherein the rotation control member is disk-shaped.

6. The extension structure for a tool in accordance with claim 1, wherein the drive section of the rotation control member is eccentrically located on the circular enlarged head of the rotation control member.

7. The extension structure for a tool in accordance with claim 1, wherein the knob of the rotation control member has a disk-shape.

8. The extension structure for a tool in accordance with claim 1, wherein the knob of the rotation control member has an elongated shape.

9. The extension structure for a tool in accordance with claim 1, wherein the shaft hole is not extended through the joint body.

10. The extension structure for a tool in accordance with claim 1, wherein the passage slot is not extended through the drive rod.
